(19) United States
(12) Patent Application Publication
(10) Pub. No.: US 2023/0210719 A1
(43) Pub. Date: Jul. 6, 2023

(54) MATTRESS SYSTEM AND METHOD OF MASSAGE

(71) Applicant: HOME HEALTH PRODUCTS GROUP SARL, Capellen (LU)

(72) Inventor: Bruno NUYTTENS, Capellen (LU)

(21) Appl. No.: 17/999,896

(22) PCT Filed: May 25, 2021
(86) PCT No.: PCT/IB2021/054523

§ 371 Date: Nov. 25, 2022

(30) Foreign Application Priority Data
May 26, 2020 (BE) 2020/5365

(51) Int. Cl. A61H 23/02

(52) U.S. Cl. CPC A61H 23/0263; A61H 2201/0146; A61H 2201/0188; A61H 2201/5012; A61H 2201/5097

(57) ABSTRACT

In a first aspect, the invention relates to a mattress system comprising a mattress, a massage module, an electronic control, a wireless communication module and an electrical power supply. In particular, the controller may receive instructions from a mobile application running on a mobile device of a user, and wherein the controller is configured to control the massage module based on a time-varying course of a motor drive signal contained in the instructions. In further aspects, the invention further provides the use of said mattress system, and a method for controlling mattress systems.

### TECHNICAL FIELD

The invention relates to intelligent mattress systems and to methods for controlling such mattress systems. The invention furthermore relates to mattress systems with a massage function.

### PRIOR ART

All kinds of mattresses, mats and beds with massage function are known from the prior art.

For example, KR 10 2012 100153 describes a massage mat. This comprises a controller and an alarm unit. The alarm unit allows the user to set a wake-up time. Once the set wake-up time has been reached, the controller will be notified thereof. Furthermore, the massage mat comprises massage means, and heating means which are activated at wake-up time, for a predetermined time. However, the setting options for the user are very limited.

In addition, CN 106 647 670 describes a mattress with a wake-up function. The mattress comprises a controller and a time module. At a preset wake-up time, the time module sends a signal to the controller. The user is awakened by light (e.g. an LED strip) and sound. This mattress does not provide massage. However, the mattress can remotely activate additional equipment.

Furthermore, EP 3 412 328 describes another electric bed with a controller, a wake-up device (e.g. via light, sound or vibrating massage) and an alarm module. Again, the alarm module allows to set a wake-up time or a wake-up period. The bed is also able to communicate with, for example, a smartphone. The user can remotely specify when and how he wants to be woken up.

Finally, US 10 398 357 describes another mattress equipped with sensors, a low-frequency electromagnetic wave generator, a controller, a Bluetooth communication module and an electric power supply. The emphasis is on the exposure of the user to so-called ‘Schumann resonance waves’, with frequencies between 7 Hz and 8 Hz. This mattress is also able to exchange information with smartphones. However, the control options for the user are limited. The user is only able to specify a number of pre-programmed massage settings. Among other things, the type of massage and the strength of the massage can be set. It is also possible to set a simple wake-up function based on vibration.

The known systems still have important shortcomings. Some provide a wake-up function, but otherwise they are not very versatile. The setting options for the user are too limited.

The present invention contemplates a system which offers more freedom to the user, and which allows their use to be personalised. At the same time, the invention contemplates a simple system that is easy to use.

### SUMMARY OF THE INVENTION

To this end, the invention provides a mattress system according to claim 1. The mattress system comprises a mattress, further provided with a massage module, an electronic controller, a wireless communication module, and an electrical power supply. In particular, the controller can receive instructions wirelessly. For example, the controller receives instructions from a mobile application (e.g. on a user’s smartphone or tablet) and/or from a web application (e.g. on a PC). It is important that the user is in any case able to communicate such instructions from the available equipment (e.g. smartphone, tablet, PC) to the mattress system, wirelessly. In addition, it is also possible that the controller receives instructions from backend software that runs on a server.

Incoming instructions are automatically loaded into a data storage of the controller. The controller is configured to control the massage module based on a time-varying course of a motor control signal contained in these instructions.

This offers broad setting options for the user. It enables the user to wirelessly (e.g. from their smartphone, tablet, PC, etc.) specify the motor control signals as a factor of time. The user is not in first instance limited to a finite number of massage types / ‘massage modes’ pre-programmed into the mattress system’s firmware.

In a further embodiment, the instructions comprise a combination of two or more control sequences (claims 2 and 14). ‘Sequences’ correspond to successive parts in the time-varying course of the motor control signals. A non-limiting example is shown schematically in FIG. 2 and accompanying description. In a further preferred embodiment, the user is free to start combining pre-programmed sequences at their discretion (claim 15), and/or to program or adapt sequences themselves (claim 16).

This makes the system versatile and easy to use at the same time. Namely, there are endless possibilities to combine a limited number of sequences. At the same time, no advanced programming knowledge is required for this. The invention offers a suitable compromise between maximum freedom for the user and maximum ease of use.

Optionally, the mattress system also comprises a light module with one or more light sources for illuminating an environment of the user. The inventors noticed a great influence of massage combined with illumination. Preferably, the aforementioned instructions herein comprise a time-varying course of at least one motor signal and a light signal (claims 4-6).

The invention further provides the use of said mattress system (claim 8), a computer-implemented system of the mattress system in communication with a server and a mobile user device (claim 9), and a method for controlling mattress systems / for massaging a user (claim 13).

### DESCRIPTION OF THE FIGURES

FIG. 1 is a schematic representation of the communication of the mattress system with a mobile user device and/or with a server, according to a possible embodiment.

FIG. 2 shows a control signal as a combination of several consecutive control sequences, according to a possible embodiment.

FIGS. 3A-B show a mattress system according to a possible embodiment, in active condition and in folded condition, respectively.

FIGS. 4A-B show a perspective drawing and a longitudinal section of a mattress system according to a possible embodiment, illustrating the massage modules.

FIGS. 5A-B show a perspective drawing and a longitudinal section of a mattress system according to a possible embodiment, illustrating the light modules.

FIG. 5C is an exploded view of a light module, according to a possible embodiment of the invention.

### DETAILED DESCRIPTION

The invention relates to a mattress system, the use of a mattress system, and a method for massaging a user.

Unless otherwise defined, all terms used in the description of the invention, including technical and scientific terms, have the meaning as commonly understood by a person skilled in the art to which the invention pertains. For a better understanding of the description of the invention, the following terms are explained explicitly.

In this document, ‘a’ and ‘the’ refer to both the singular and the plural, unless the context presupposes otherwise. For example, ‘a segment’ means one or more segments.

When the term ‘around’ or ‘about’ is used in this document with a measurable quantity, a parameter, a duration or moment, and the like, then variations are meant of approx. 20% or less, preferably approx. 10% or less, more preferably approx. 5% or less, even more preferably approx. 1% or less, and even more preferably approx. 0.1% or less than and of the quoted value, insofar as such variations are applicable in the described invention. However, it must be understood that the value of a quantity used where the term ‘about’ or ‘around’ is used, is itself specifically disclosed.

The terms ‘comprise’, ‘comprising’, ‘consist of’, ‘consisting of’, ‘provided with’, ‘have’, ‘having’, ‘include’, ‘including’, ‘contain’, ‘containing’ are synonyms and are inclusive or open terms that indicate the presence of what follows, and which do not exclude or prevent the presence of other components, characteristics, elements, members, steps, as known from or disclosed in the prior art.

Quoting numerical intervals by endpoints comprises all integers, fractions and/or real numbers between the endpoints, these endpoints included.

In a first aspect, the invention relates to a mattress system comprising a mattress adapted to support a user, which mattress system further comprises:
a massage module contained in the mattress, with at least one motor for massaging the user,
an electronic controller provided on or in the mattress, and operatively connected to the massage module, configured to control the massage module on the basis of motor control signals loaded into a data storage of the controller,
a wireless communication module provided on or in the mattress, and operably connected to the controller, configured to wirelessly receive instructions for massaging the user, and
an electric power supply connected to the massage module, the electronic controller and the wireless communication module.

In particular, said instructions comprise a time-varying course of a motor control signal, the controller being configured for uploading the motor control signal according to the time-varying course into the data storage of the controller, and for controlling the motor based on the motor control signal. Optionally, the controller can receive said instructions from a mobile application running on a mobile user device (e.g. a smartphone or tablet) of the user, and wherein the controller is configured to control the massage module based on a time-varying course of a motor control signal contained in the instructions.

‘Mattress’ as referred to herein should be understood as broadly as possible in first instance. It can refer to a mattress unit, but just as well to a mattress layer (e.g. a top layer, intermediate layer or bottom layer) from a multi-layer mattress unit. The invention is not limited to any of these. Preferably, a ‘mattress’ is at least adapted to support a user seated or lying on or above the mattress directly or indirectly (with any further intermediate layers). Optionally, the mattress includes a foam. Optionally, the mattress is foldable, with two or more mattress segments and fold lines in between. Optionally, the mattress segments are provided with a common cover layer. Optionally, a fold line is formed by an incision between the segments, up to or against the cover layer. At the height of the fold lines, any wiring preferably runs against or in the cover layer. A wiring thus does not interfere with the incisions and/or the foldability of the mattress. Optionally, the mattress system includes one or more pressure sensors to detect whether a user is lying or sitting on the mattress.

A ‘wireless communication’ as mentioned above can refer to any analogue or digital communication between electronic equipment. Wireless communication is not limited by a used protocol in the first instance. A non-exhaustive list of examples of possible wireless communication technologies includes: 2G, 3G, 3GPP, 4G, 5G, 6LowPAN, Bluetooth, Bluetooth 4.0, Bluetooth 4.1, Bluetooth 4.2, Bluetooth 5, Bluetooth Low-Energy, CDMA, CDMA2000, Cellular, EDGE, EDGE Evolution, Ethernet, EV-DO, Flash-OFDM, GPRS, 15 GSM, HIPERMAN, HSPA, iBurst, IEEE 802.11a, IEEE 802.11ac, IEEE 802.11b, IEEE 802.11g, IEEE 802.11n, IEEE 802.15.4, IEEE 802.15.4, IEEE 802.15.4-2006, IEEE 802.16, IEEE 802.16-2009, IEEE 802.16m, IEEE 802.20, Internet, IPv4, IPv6, LAN, LoRaWAN, Low Rate WPAN, LTE, Near Field Communication, Neul, RTT, Sigfox, Thread, UMTS, UMTS W-CDMA, UMTS-TDD, USB, UWB, WAN, Weightless, Wi-Fi, WiMAX, 20 Wireless USB, WLAN, WWAN, ZigBee and Z-Wave.

A ‘mobile user device’ as mentioned above is an electronic device capable of communicating with the mattress system. Non-limiting examples are a smartphone and a tablet. The invention is not limited to any of these in first instance. Preferably, the mattress system can be controlled from a mobile application (= a mobile user application) which is accessible to the user from the mobile user device. Additionally or alternatively, the mattress system may preferably be controlled from a web application that is accessible to the user from a user device (e.g. a PC) with internet connection. The invention is not limited to any of these in the first instance.

A ′server′ as referred to herein is understood as an electronic device having a processor, a communication module and a storage medium. The expression ‘server configured for ...’ should be understood as meaning ‘a server with suitable hardware adapted to perform..., and where the storage medium includes software instructions for ...’. Optionally, the server and/or the software present on the server is referred to as the ‘backend’.

An ‘electric power supply’ as used above can refer to an actual power source (e.g. a battery), or to a connection suitable for connecting the mattress system to a separate power source (e.g. the mains).

A ‘motor control signal’ as mentioned above can preferably be translated into an input for the motor, for controlling the motor. A possible synonym is a ‘motor amplitude’. Optionally, a higher value of the motor control signal corresponds to a more intense actuation of the motor. According to a possible embodiment, the motor control signal is proportional to a corresponding analogue or digital control value used to control the motors via wiring provided in the mattress. The control value may represent an electrical voltage and/or an electrical current.

The motor control signal has a time-varying course. That is, within a certain period of time, the motor control signal has a non-constant value other than zero. The motor control signal is different from zero; i.e. the motor is activated within that time frame resulting in a massage of the user. Moreover, the motor control signal is non-constant (i.e. variable); i.e. the motor is activated within that time period in a time-varying manner. The time-varying activation of one or more motors provides a richer massage that varies with time. This makes it possible to prevent habituation on the part of the user. It is also possible to massage in phases, as explained below. Importantly, the mattress system is not merely limited to on/off, or even to a choice between two or more pre-programmed massage modes. Rather, the invention provides direct control of the time-varying course of the motor control signal, from a mobile user device (e.g. a smartphone) or from the backend (e.g. a central server).

The ‘instructions’, as mentioned above, comprise at least information relating to a ‘time-varying course of a motor control signal’. That is, preferably the motor control signal varies in time, wherein the instructions describe either the motor control signal in its entirety or a time-varying course thereof. In a possible embodiment, the instructions comprise a complete dataset with values of the motor control signal as a function of time, e.g. at 100 ms intervals. In another possible embodiment, the instructions include at least one time point, a motor amplitude for that time point, and a description of the course of the motor amplitude from that time point (e.g., a fade factor). The invention is not limited to any of these. Optionally, the instructions are contained in an electronic file. A JSON file can be a suitable format for this. Of course, the invention is not limited thereto.

The instructions are loaded into a data storage of the controller. They therefore preferably form part of the controller since they are stored in a data storage (= memory) of the controller. The controller, in turn, is configured to receive the instructions from a mobile application. That is, the controller comprises a program which upon execution will receive instructions from such a mobile application. These instructions are then loaded into the data storage to control the massage module based on them.

Preferably, the controller comprises the necessary firmware to execute motor control signals loaded into the data storage. ‘Firmware’ or embedded software is the software programmed for this purpose in the controller.

A potentially important advantage is that the mattress system allows the user to control the motor control signal themselves from their mobile application. For example, the user is not limited to a number of pre-programmed massage modes in the firmware of the device itself, as is often the case in the prior art. The user can intervene directly on the motor control signal itself, namely on the input of the motor.

Optionally, the mattress system further comprises a light module incorporated in the mattress, with at least one light source for illuminating an environment of the user. Preferably, if necessary, the controller is also configured to control the light module, based on the instructions. More preferably, the light module can be controlled with a variable wavelength (~colour in the case of visible light) and/or intensity. The instructions then preferably also contain a time-varying course of a light control signal for controlling the light module. The same explanation and the same features/advantages as for the time-varying course of the motor control signal may apply equally. According to a further embodiment, the user is thus able to control both the massage module and the light module, from their mobile application. In particular, the user can preferably intervene directly on the light control signal / the light amplitude itself, namely on the input of the light source.

In a further or alternative embodiment, the instructions comprise a combination of two or more control sequences (e.g. light control sequences / illumination sequences or motor control sequences / massage sequences), which sequences correspond to successive parts in the time-varying course of the motor control signal and/or light control signal. Massage sequences / motor control sequences correspond to the time course of the control values for one or more of the motors. Illumination sequences / light control sequences correspond to the time course of the amplitudes for one or more of the LEDs. Both can be stored in a server via the mobile application.

According to a non-limiting example, the time-varying course of the motor control signal allows to specify a massage with different phases. A first phase may be primarily aimed at stimulating blood flow and lymph flow, which corresponds to a first control sequence. A second phase can mainly be aimed at stretching muscle mass and blood circulation in the muscles. This is represented by a second, subsequent control sequence. A third phase can mainly focus on relaxing the muscles. This is accompanied by a third, subsequent control sequence.

Optionally, the user will request one pre-programmed control sequence from a library. Optionally, the user will program or modify at least one control sequence themselves, specifying:
at least one time point,
at least one motor or light source (e.g. by means of an identifier, at least if the system provides more than one motor / more than one light source),
a corresponding motor control signal value or light control signal value, and
a fading factor.

This makes the system versatile and easy to use at the same time. Namely, there are endless possibilities to combine a limited number of control sequences into a control program (contained in the ‘instructions’). The individual sequences themselves can be designed by specialists. At the same time, no advanced programming knowledge is required for this. The invention offers a suitable compromise between maximum freedom for the user and maximum ease of use. If desired, the user can configure control sequences themselves (e.g. program or adapt). A ‘combination’ of multiple sequences indicates a sequence of sequences. An example is that the same sequence (of e.g. 10 seconds) is repeated several times. Another example is that different sequences are played one after the other. Motor control sequences and light control sequences are independent of each other and can be combined in parallel if desired.

Preferably, each sequence specifies at least one time point, at least one motor or light source, a corresponding motor amplitude (motor control signal) or light amplitude (light control signal), and optionally a fading factor. Fading factors can be especially effective for light modules. They can have a calming effect. Thus, preferably there is no fading for the motor control signal. That is, the fading factor is zero. An advantage of such a structure for the sequences is that they are very simple and require little data storage. Yet this is sufficient to provide a sufficiently rich control signal for the comfort of the user via a combination of several signals.

Optionally, the massage module comprises two or more motors, with the instructions adapted for controlling each of the motors. The instructions herein each time provide a motor identifier to indicate for which motor a specified motor control signal is intended. Optionally, the light module includes two or more light sources. Corresponding light identifiers indicate for which light source a light control signal is intended.

Preferably, any motors of the massage module are incorporated in a central zone along the longitudinal direction of the mattress. That is, where the user sits on the mattress. Optionally, wiring between the motors and the controller is incorporated in one or both edge zones, on either side of the central zone, also in the longitudinal direction. Preferably (as described above), in the case of a foldable mattress, the wiring runs against or in a cover layer. The fact that the wiring is mainly located in an edge zone has the advantage that the user will not perceive it during normal placement on the mattress.

Optionally, the mattress system is furthermore provided with a sound module included in the mattress, for generating music and/or sound in the user’s environment.

In a possible embodiment (as already described above), the mattress system is provided with a light module contained in the mattress, with at least one light source for illuminating an environment of the user, operatively connected to the controller. In a non-limiting example, this may be LED modules which are concealed in the circumference of the mattress, and which are oriented laterally with respect to the mattress. According to another example, it may be an infrared module that acts on the user themselves to warm up body parts of the user. It is emphasised that the ‘light module’ serves as a treatment for the user. The light module is thus adapted to generate a considerable light intensity. One or more indicator LEDs on the mattress have a completely different function, so they do not fall under the term ‘light module’. Optionally, the light module is adapted to generate visible light with a configurable colour and/or intensity. Optionally, the light module is adapted to generate infrared light with a configurable intensity.

Treatment via exposure to infrared light can cause warming. Warming up can lead to the dilation of blood vessels, which further enhances the effect of a simultaneous massage treatment.

In a further or alternative embodiment, the system further comprises one or more sensors provided on or in the mattress, adapted for collecting biophysical measurement data relating to the user. The collection of measurement data, in this case during the massage (or alternatively via a wearable that the user wears during the day), allows to further regulate the motor control signals for the mattress system. Namely, the measurements allow to map the effect of the treatment. If necessary, the treatment is adjusted. Optionally, the treatment is fine-tuned in several iterative steps.

In a further aspect, the invention relates to the use of the mattress system as described above by the user. The same features and advantages can therefore be reiterated in this regard.

In a further aspect, the invention relates to a computer-implemented system comprising the mattress system as described above, and further comprising:
a mobile user device with a mobile user application, and
a server with backend software,
both configured to exchange data with the controller of the mattress system, via the wireless communication module.

Optionally, the server is only able to communicate directly with the mattress system once a user has created a user account on the server, whereby the user also makes contact with the mattress system from their mobile application (and logs into the user account). In this regard, the mattress system is preferably offered access to a wireless communication network (e.g. the user’s Wi-Fi network), whereby the mattress system is able to communicate directly with the backend, at least insofar as it concerns the writing of user data and/or any measurement data to the backend, or to receive remote user information (with the mobile user device not in close proximity to the mattress system for direct communication).

In a further aspect, the invention relates to a method for massaging a user via a mattress system comprising a mattress, a massage motor, a wireless communication module and a controller, with the controller operatively connected to the massage motor and the communication module, the method comprising controlling of the massage motor via the controller based on a motor control signal. In particular, instructions comprising the motor control signal and/or a time-varying course of the motor control signal are received wirelessly via the communication module, from a mobile user application on a mobile user device, and/or from backend software on a server. Optionally, the method is adapted for controlling the mattress system described above, and/or the computer-implemented system described above. The same features and advantages can therefore be interchanged. Optionally, the mattress system also includes one or more light modules as described above.

In a further or alternative embodiment, the user previously generates the motor control signal and/or its time-varying course by combining two or more control sequences, which sequences correspond to successive parts in the time-varying course of the motor control signal. Another advantage is the compromise between the great freedom of setting on the one hand, and the simplicity and ease of use of the system on the other.

Optionally, the user requests at least one pre-programmed sequence from a library, for example via the mobile application. Such pre-programmed sequences can be set up by specialists for optimal massage and/or lighting. Alternatively, the user will program or modify at least one sequence themselves, specifying at least one time point, at least one motor/light source, a corresponding motor control signal / light control signal and optionally a fading factor.

In a further or alternative embodiment, the user makes a selection of:
either a direct mode of immediate/direct control based on the instructions,
or a wake-up mode with user specification of a delayed start time (e.g. at 7:42 am) and a repetition rate (e.g. daily excluding Sunday).

The mattress system is not limited to a wake-up function only. Direct control is accompanied by direct loading of a motor control signal (or its time-varying course) into the data storage of the controller. Optionally, the instructions are removed after direct control is over. In the case of the wake-up mode, the motor control signal (or its time-varying course) is stored in the controller’s data storage for a longer period of time. This until they are changed or removed. Preferably, moreover, several instructions can be loaded side by side in the data storage (e.g. several wake-up modes, each with a corresponding start time and repetition rate).

According to a possible embodiment, the method is used for waking the user at a specific time (e.g. 7:00 am), with a specific repetition rate (e.g. daily). In addition, the method comprises the step of receiving instructions by the communication module, wirelessly from the mobile application, which instructions specify a motor control signal (or a time-varying course thereof), as well as a time and a repetition rate.

In a further or alternative embodiment, the user is logged in to a corresponding user account, and usage data and/or measurement data linked to that account is stored on a server. This allows, among other things, to save favourite control programs and control sequences. The measurement data can also be used to propose modified control programs on the basis of already executed control programs and where the measurement data (e.g. a measure of the effectiveness of treatments already performed) is taken into account. All this can be done through an iterative process. In particular, the motor control signal and/or its time-varying course can be modified, based on the collected measurement data.

In a further or alternative embodiment, the user carries with them means (e.g. a stress meter wristband) for measuring stress and/or activity, which means are configured for communication with the mobile user device and/or with the controller. Thus, it concerns means for monitoring the user, in particular measuring means for collecting measurement data relating to stress and/or activity of the user, preferably prior to their use of the mattress system. For example, the physical condition (movement, stress level, blood pressure) of the user is measured during the day. This is passed on to the controller. Based on this, the wake-up time and/or wake-up method is adjusted. It is also possible to propose certain massage sequences and/or light sequences based on this. Of course, the invention is not limited thereto. Monitoring can be done on the basis of electrodermal activity, on the basis of temperature, and/or on the basis of movement.

In a further or alternative embodiment, the motor is stochastically controlled. The term ‘andullation’ refers to a biophysical treatment based on stochastically produced, low-frequency vibrations. Optionally, the mattress system is adapted to perform an andullation treatment on the user. Optionally, such vibrations are supplemented with infrared radiation.

In a further aspect, the invention relates to a mobile application for controlling a mattress system, according to a method as described above.

In a further aspect, the invention relates to a computer-implemented system comprising the mattress system as described above, and further comprising a mobile application for controlling the mattress system, which application is thereby capable of sending said instructions to the controller of the mattress system, via the wireless communication module.

In what follows, the invention is described by way of non-limiting examples illustrating the invention, and which are not intended to and should not be interpreted as limiting the scope of the invention.

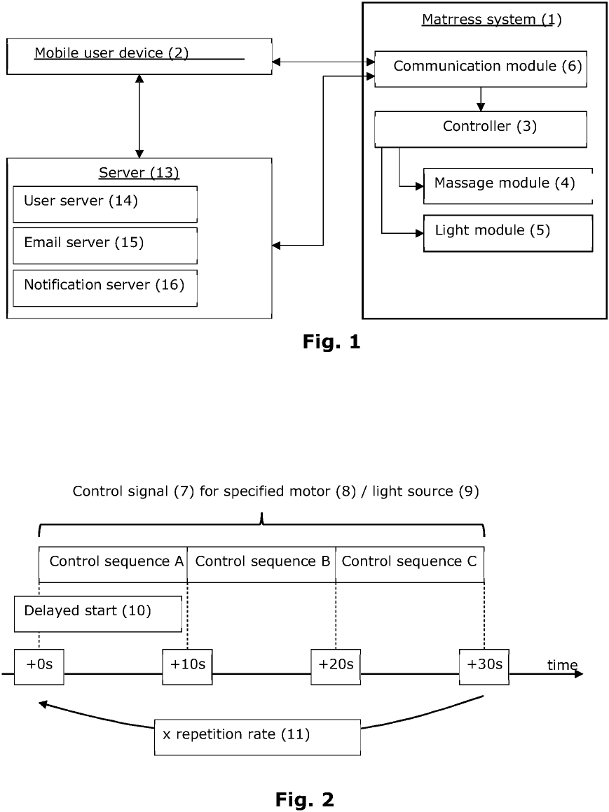

FIG. 1 is a highly simplified, schematic representation of the communication between the mattress system (1), a mobile user device (2) and a server (13), according to a possible embodiment. The mattress system (1) comprises a controller (3) for controlling the massage module (4) and the light module (5), which controller (3) is connected to a communication module (6) for wireless communication with the mobile user application that can be accessed from the mobile user device (2). At the same time, the mobile user application (12) is able to exchange information with a server (13). The mattress system (1) can also communicate directly with the server (13) provided that the user has created a user account on the server (13), whereby that user account has been linked to the concerned mattress system (1). Corresponding identification means for the user account and the mattress system (1) were exchanged. The mattress system (1) is now able to upload usage data to a user server (14). The email server (15) can be used for communication with the user by email. Notifications to the user originate from the notification server (16). Optionally, the mattress system (1) is also capable of collecting biophysical measurement data upon operation, and also uploading it to the user server (14).

Alternatively (not shown) it is still possible for the user to communicate with the mattress system via a web application which is accessible to the user from any user device with internet connection. The web application preferably runs on the server, whereby the server is further preferably able to communicate directly with the mattress system (e.g. for passing on the so-called ‘instructions’).

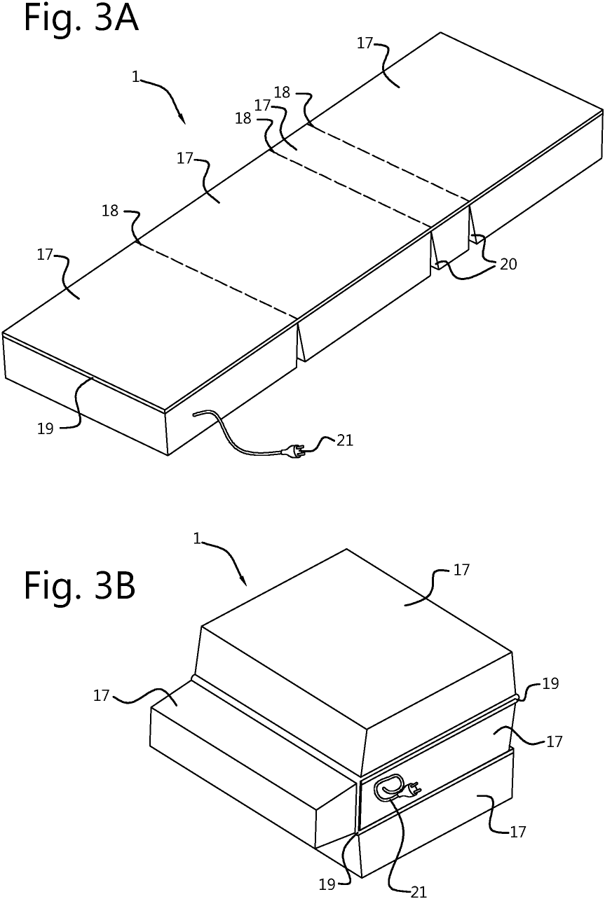

FIG. 2 shows a control signal (7) as a combination of several consecutive control sequences A, B and C, according to a possible embodiment. Optionally, this is a control signal for a motor (8) of the massage module (4). Alternatively, it is a control signal for a light source (9) of the light module (5). Preferably, each control sequence specifies a time point (e.g. 0 s, 10 s or 20 s), an identifier for the motor (8) or light source (9), a control signal value, and optionally a fading factor. Together, the control sequences A+B+C form a control signal (8) with a time-varying course. That is, the amplitude is not constant but varies with time. Optionally, a delayed start (10) and a repetition rate (11) can be specified for use of the wake-up mode.

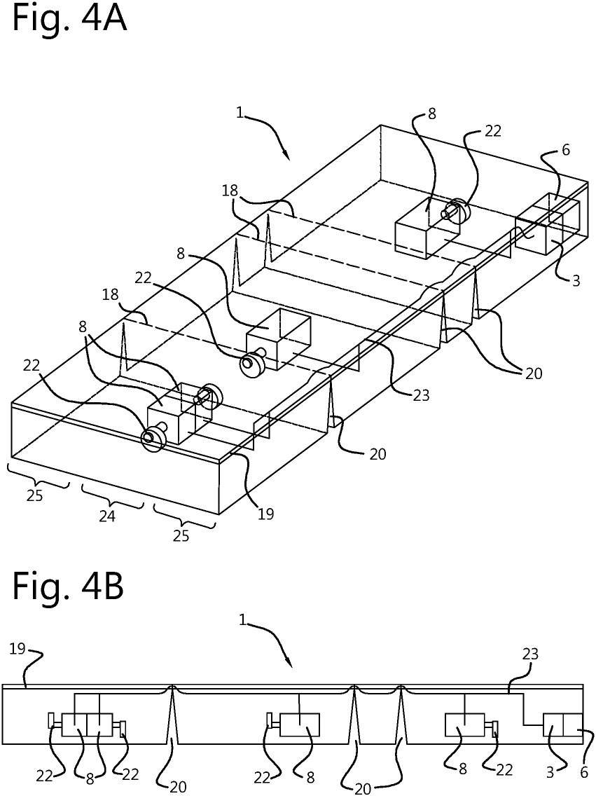

FIGS. 3A-B show a mattress system 1 according to a possible embodiment, in an active condition (FIG. 3A) and in a folded condition (FIG. 3B), respectively.

The mattress system 1 comprises a support body formed by four mattress segments 17 with fold lines 18 between them. Preferably, the mattress segments 17 offer a certain compressive elasticity to comfortably support the user. The mattress segments preferably also offer a certain permeability to vapours and/or liquids, for the drainage of body fluids (particularly sweat). Along the top side shown (FIG. 3A), the mattress segments 17 are interconnected via a cover layer 19. For example, it concerns a layer which is glued to the mattress segments 17. Fold lines 18 and any stitching between the segments 17 are therefore not perceptible from the top. Along the turned away underside (FIG. 3A), the fold lines form incisions 19 between the segments 17, preferably up to the cover layer 19. They allow mutual folding of the mattress segments 17. A possible folded condition is shown in FIG. 3B. The mattress system 1 is further provided with an electrical connection/power supply 21.

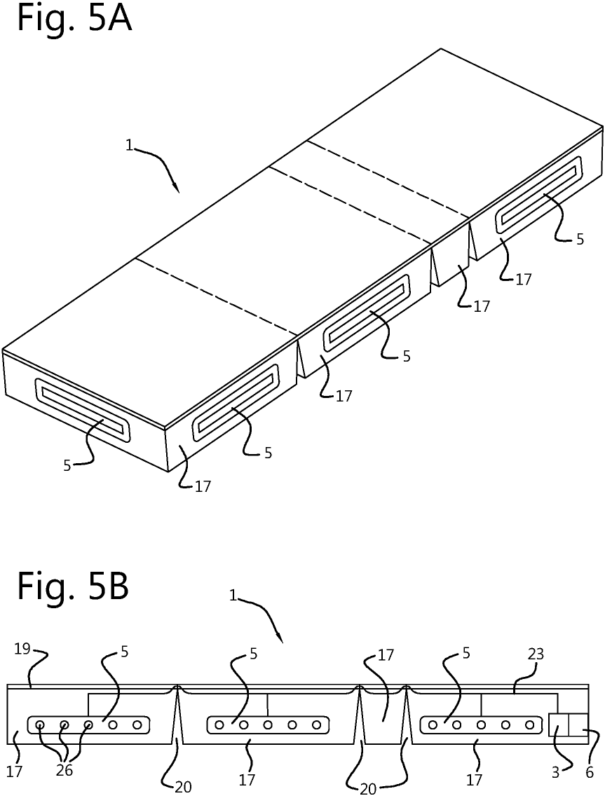

FIGS. 4A-B show a perspective drawing and a longitudinal section of a mattress system 1, according to a possible embodiment. Three mattress segments 17 each provide a massage module 4 (here indicated via 8 and 22), connected via a wiring 23 to the controller 3 (with wireless communication module 6). At the level of the incisions 20 mentioned, the wiring 23 runs against or even partially in the cover layer 19.

Each massage module 4 comprises one or more motors 8, each equipped with an eccentrically placed centrifugal mass 22. When the motors 8 are rotated, these masses 22 develop vibrations. The vibrations are transferred via the mattress foam to a user who is located on the mattress segments 17. Preferably, the speed of the motors 8 can be controlled from the controller 3, for instance via a frequency controller. The vibration frequency is preferably located between 1000 and 0.1 Hz, more preferably the vibration frequency is at least 1 Hz, more preferably at least 10 Hz. More preferably a maximum of 100 Hz. The massage modules 4 are arranged in a central zone 24 extending in the longitudinal direction of the mattress. Preferably, the wiring 23 runs at least partially or even mainly in one or both edge zones 25 on either side of the central zone 24. Preferably, the motors 8 and flyweights 22 are located sufficiently deep in the mattress 1, so that they are only perceived indirectly (i.e. via massaging vibrations from the mattress foam) by the user.

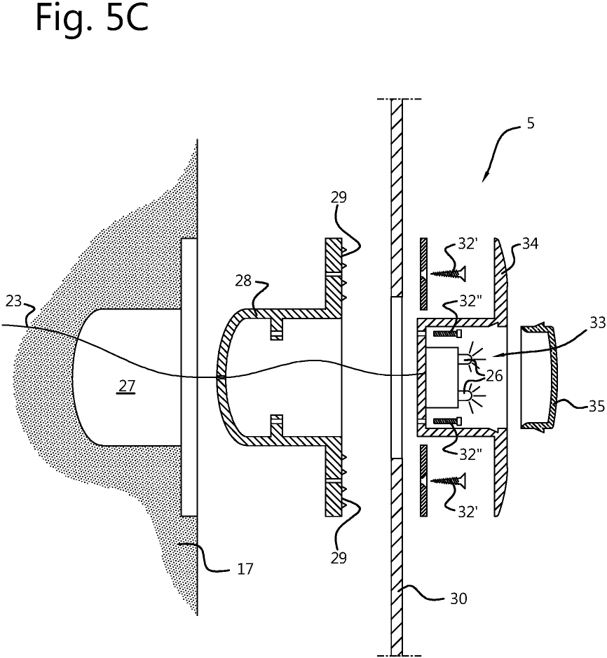

FIGS. 5A-B show a perspective drawing and a longitudinal section of a mattress system 1 according to a possible embodiment. The system 1 provides several light modules 5, arranged along a lateral circumference of the mattress system 1. The light modules 5 are arranged laterally in the mattress segments 17. Each light module 17 includes a plurality of light sources 26 (e.g. LEDs). A wiring 23 connects the light modules 17 to the controller 3, in turn connected to the communication module 6. At the level of the incisions 20, the wiring 23 runs against the cover layer 19 of the mattress system 1.

Optionally, the light modules according to FIGS. 5A-B are an addition to the mattress system 1 with massage modules 8, 22 according to the embodiment of FIGS. 4A-B.

FIG. 5C is a schematic exploded view of a light module 5 according to a possible embodiment of the invention. The figure shows a simplified design. The light module 5 includes a housing 28 adapted for receiving within a complementary receiving cavity 27 (formed in one of the mattress segments 17). The receiving cavity 27 is provided laterally in the mattress segment 17. The receiving cavity 27 is preferably enclosed by only one mattress segment 17. It does not interfere with the foldability of the mattress segments 17. The housing 28 is preferably glued into the receiving cavity 27. Further wiring 23 for connection to a controller 3 can be concealed in the mattress segment 17 itself.

The housing 28 forms another forward opening, rimmed by a circumferential flange 29 of the housing 29. When installed, this circumferential flange 29 preferably comes to be flush with the surface of the mattress segment 17. The circumferential flange 29 provides a circumferential, outward roughening which is better able to engage a mattress cover 30 of the mattress segment 17. At the level of the light module 5, this cover 30 will namely be clamped between the circumferential flange 29 and a further clamping ring 31, with a fastening via screws 32′.

The light module 28 further comprises an insert 33 which can be fitted over the housing 28, and which can be mounted in the housing 28 via further screws 32″. The insert 33 provides direct mounting for one or more light sources 26. It forms a visible circumferential edge 34 with a light opening inside, which can be closed via a translucent screen 35. Optionally, the insert 33 is made of aluminium so that it provides a circumferential edge 34 with a clean look.

The numbered elements in the figures are as follows

| | |
|---|---|
| 1 | mattress system |
| 2 | mobile user device |
| 3 | controller |
| 4 | massage module |
| 5 | light module |
| 6 | communication module |
| 7 | control signal |
| 8 | motor |
| 9 | light source |
| 10 | delayed start |
| 11 | repetition rate |
| 12 | mobile user application |
| 13 | server |
| 14 | user server |
| 15 | email server |
| 16 | notification server |
| 17 | mattress segment |
| 18 | fold line |
| 19 | cover layer |
| 20 | incision |
| 21 | power supply |
| 22 | eccentric mass |
| 23 | wiring |
| 24 | central zone |
| 25 | edge zone |
| 26 | light source |
| 27 | receiving cavity |
| 28 | housing |
| 29 | circumferential flange |
| 30 | cover |
| 31 | clamping ring |
| 32 | screw |
| 33 | insert |
| 34 | circumferential edge |
| 35 | translucent screen |

The present invention should not be construed as being limited to the embodiments described above and certain modifications or changes may be added to the examples described without having to re-evaluate the appended claims.

1. A mattress system comprising a mattress adapted to support a user, which mattress system further comprises:
a massage module contained in the mattress, with at least one motor for massaging the user,
an electronic controller provided on or in the mattress, and operatively connected to the massage module, configured to control the motor on the basis of motor control signals loaded into a data storage of the controller,
a wireless communication module provided on or in the mattress, and operably connected to the controller, configured to wirelessly receive instructions for massaging the user, and
an electric power supply, operatively connected to the massage module, the wireless communication module and the controller, characterised in that said instructions comprise a time-varying course of a motor control signal, the controller being configured for uploading the motor control signal according to the time-varying course into the data storage of the controller, for controlling the motor.

2. The mattress system according to claim 1, wherein the instructions specify two or more consecutive control sequences for the motor control signal.

3. The mattress system according to claim 2, wherein each control sequence comprises:
at least one time point,
a signal value, and
a fading factor.

4. The mattress system according to claim 1, further comprising a light module contained in the mattress, with at least one light source for illuminating an environment of the user, and operatively connected to the controller.

5. The mattress system according to claim 4, with the controller configured to vary a light intensity and/or a wavelength of the light source based on light control signals loaded into the data storage.

6. The mattress system according to claim 4, wherein the instructions further comprise a time-varying course of a light control signal, and wherein the
controller is further configured for uploading the light control signal according to the time-varying course into the data storage, for controlling the light source.

7. The mattress system according to claim 1, further comprising one or more sensors provided on or in the mattress, adapted to collect biophysical measurement data related to the user.

8. The use of the mattress system according to claim 1.

9. A computer-implemented system comprising the mattress system according to claim 1, and further comprising:
a mobile user device with a mobile user application, and
a server with backend software,
both configured to exchange data with the controller of the mattress system, via the wireless communication module.

10. The system of claim 9, configured for recording usage data by means of the controller, which usage data is stored on the server associated with a user account of the user.

11. The system according to claim 9, configured for collecting biophysical measurement data by means of one or more sensors included in or on the mattress, which measurement data is stored on the server, linked to a user account of the user.

12. The system of claim 11, with the server configured to send to the communication module modified instructions for massaging the user, based on the measurement data.

13. A method of massaging a user via a mattress system comprising a mattress, a massage motor, a wireless communication module and a controller, with the controller operatively connected to the massage motor and the communication module, the method comprising controlling the massage motor via the controller based on a motor control signal, characterised in that instructions comprising the motor control signal and/or a time-varying course of the motor control signal are received wirelessly via the communication module, from a mobile user
application on a mobile user device, from a web application on a user device with internet connection, and/or from backend software on a server.

14. The method of claim 13, wherein the user previously generates the motor control signal and/or its time-varying course by combining two or more control sequences in succession.

15. The method of claim 14, wherein the user requests at least one standard preprogrammed control sequence from a library.

16. The method according to claim 14, wherein the user programs or modifies at least one control sequence themselves, specifying:
at least one time point,
a signal value, and
a fading factor.

17. The method according to claim 13, wherein the user makes a selection of:
either a direct mode of immediate control based on the instructions, or a wake-up mode with user specification of a delayed start time and repetition rate.

18. The method according to claim 13,
wherein the user is logged in to a corresponding user account via the mobile application or web application,
wherein usage data is registered by means of the controller, and
wherein the usage data is stored on the server linked to the user account of the user.

19. The method according to claim 13,
wherein the user is logged in to a corresponding user account via the mobile application or web application,
wherein biophysical measurement data is collected by means of one or more sensors in or on the mattress, and
wherein the measurement data is stored on the server, linked to the user account of the user.

20. The method according to claim 13, wherein the user carries measuring means on them for collecting measurement data relating to stress and/or activity.

21. The method according to claim 13, wherein the server sends modified instructions to the communication module, comprising a modified motor control signal and/or a modified time-varying course of the motor control signal, with changes based on the collected usage data and/or measurement data.

22. A mobile application or web application for controlling a mattress system, according to a method according to claim 13.
